(19) United States
(12) Patent Application Publication
(10) Pub. No.: US 2026/0187544 A1
(43) Pub. Date: Jul. 2, 2026

(54) ENSEMBLE MACHINE LEARNING MODELS FOR PREDICTION AND UNCERTAINTY QUANTIFICATION OF NETWORK USAGE EXPERIENCE AND CONFERENCE APPLICATION EXPERIENCE

(71) Applicant: Fortinet, Inc., Sunnyvale, CA (US)

(72) Inventors: Siva Yogendra Jupudi, Bangalore (IN); Zahoor Ahmed Kazi, Bangalore (IN); Srikaran Shanmukha, Bangalore (IN); Sudhanshu Shandilya, Bangalore (IN); Raveendra Joshi, Bangalore (IN); Sudheer Nagurla, Bangalore (IN); Joel Kingston, Bangalore (IN)

(73) Assignee: Fortinet, Inc., Sunnyvale, CA (US)

(21) Appl. No.: 19/004,178

(22) Filed: Dec. 27, 2024

(51) Int. Cl. G06N 20/20

(52) U.S. Cl. CPC G06N 20/20

(57) ABSTRACT

Data sets are analyzed with EDA for determining feasible data for training. Monitoring of stations can be passive by snooping data packets, and can be active by direct communication with an operating system. A conference application currently running on a specific station is detected from data packets associated with the specific station. A set of channel experiences and a set of conference application experiences are predicted using the experience prediction model. A sliding window can define a time period for predictions and weighting can define relativity between different inputs. The experience prediction module has been trained with validated channel statistics collected at network sensors dispersed at different locations on the enterprise network.

### FIELD OF THE INVENTION

The invention relates generally to computer networks, and more specifically, to proactively identify problems in user experience with machine learning when using conference applications.

### BACKGROUND

In an enterprise network, there are thousands of clients connected, and it is very complex for network administrator to proactively identify problematic clients and the root cause. There are 235 features, like SNR, Channel Utilization, and Data Rates, and the like, generated for every wireless client on the network. These features vary dynamically over time due to the nonlinear nature of wireless communication and the diversity of wireless clients, further complicating the identification process.

Many conventional conferencing systems ask for feedback on experience after the call, missing a window for real-time corrections. Furthermore, network and application conditions dynamically change, causing older collected data to become stale as no longer relevant to current conditions.

Therefore, what is needed is a robust technique for proactively identifying problems in user experience with machine learning when using conference applications.

### SUMMARY

To meet the above-described needs, methods, computer program products, and systems for load balancing ADC server for proactively identifying problems in user experience with machine learning when using conference applications.

In one embodiment, data sets are analyzed with EDA for determining feasible data for training.

In another embodiment, data traffic associated with a specific station on the enterprise network is monitored, along with other stations. Monitoring of stations can be passive by snooping data packets, and can be active by direct communication with an operating system. For example, the operating system assists execution of a conference application and can send a notification. A conference application currently running on a specific station is detected from data packets associated with the specific station.

In yet another embodiment, a set of channel experiences and a set of conference application experiences are predicted using the experience prediction model. A sliding window can define a time period for predictions (e.g., 1, 3, or 15 minute windows) and weighting can define relativity between different inputs. The experience prediction module has been trained with validated channel statistics collected at network sensors dispersed at different locations on the enterprise network. The set of channel predictions and the set of conference application experiences can be categorized to determine whether the network experience or the conference application experience are predominately network based, predominately device based, or a combination. When accuracy rates of predictions fall below a threshold, the experience predication model can be retrained with more feasible data.

In still another embodiment, an action is taken based on the categorization. For example, a network administrator can be notified, an automated action can be taken, or conditions can be reported in batch or as discovered.

Advantageously, network and network device performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for proactively identifying problems in user experience with machine learning when using conference applications, according to some embodiments.

FIG. 2 is a more detailed block diagram illustrating an AI operations device of the system of FIG. 1, according to an embodiment.

FIGS. 3A and 3B are tables illustrating model evaluation results for Network Experiences and Application Experiences, according to an embodiment.

FIG. 4 is a high-level flow diagram illustrating a method for proactively identifying problems in user experience with machine learning when using conference applications, according to an embodiment.

FIG. 5 is a more detailed flow diagram illustrating a step for predicting, with an experience prediction model, a set of channel experiences and a set of conference application experiences, from the method of FIG. 4, according to an embodiment.

FIG. 6 is a block diagram illustrating an example computing device for the system of FIG. 1, according to an embodiment.

### DETAILED DESCRIPTION

Methods, computer program products, and systems for proactively identifying problems in user experience with machine learning when using conference applications. The following disclosure is limited only for the purpose of conciseness, as one of ordinary skill in the art will recognize additional embodiments given the ones described herein.

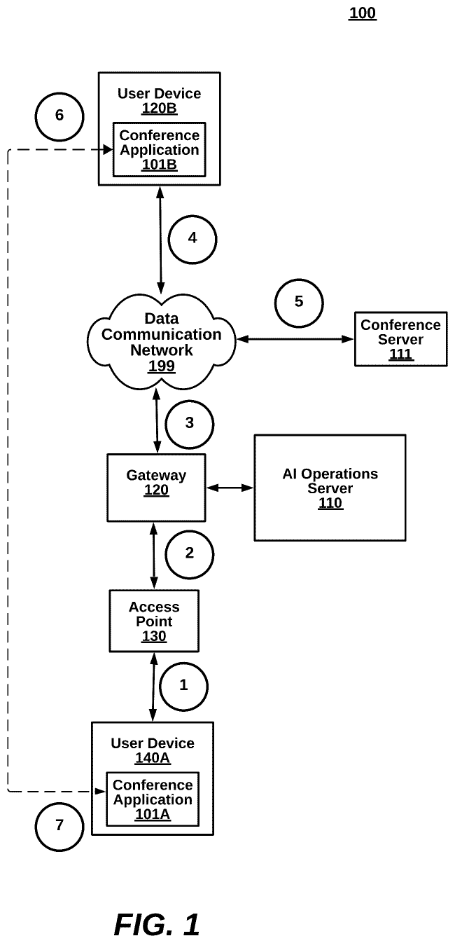

### I. Systems for Conference Application Experience (FIGS. 1-3)

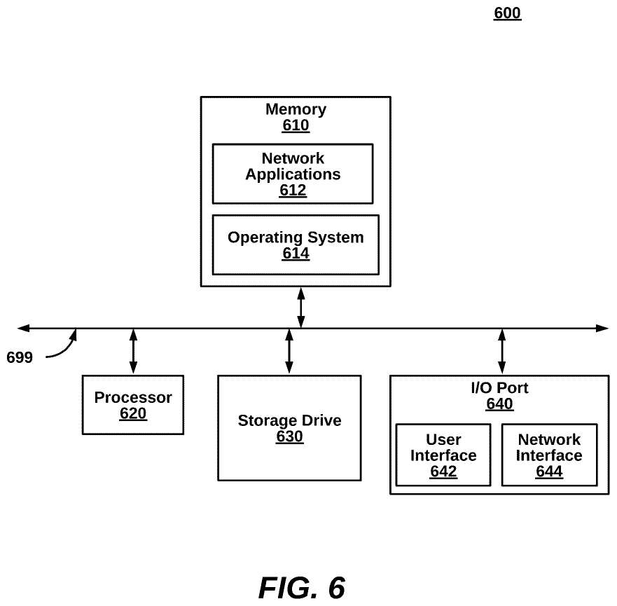

FIG. 1 is a high-level block diagram illustrating a system 100 for proactively identifying problems in user experience with machine learning when using conference applications, according to an embodiment. The system 100 includes an Artificial Intelligence (AI) operations server 110, a gateway device 120, an access point 130 and a user device 140. Other embodiments of the system 100 can include additional components that are not shown in FIG. 1, such as additional servers and gateways, along with Wi-Fi controllers, access points, routers and switches. The components of system 100 can be implemented in hardware, software, or a combination of both. An example implementation of processor-based hardware components is shown in FIG. 6.

In one embodiment, components of the system 100 are coupled in communication over a private (or enterprise) network connected to a public network, such as the Internet. In another embodiment, system 100 is an isolated, private network, or alternatively, a set of geographically dispersed LANs. The components can be connected to the data communication system via hard wire (e.g., AI operations server 110, gateway device, Wi-Fi controllers, routers, switches, and the like). The components can also be connected via wireless networking (e.g., wireless stations and mesh networking nodes). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

A conference application 101A can be, for example, Microsoft Teams, Zoom, WhatsApp, Apple FaceTime, Google Meet, or other video conferencing mechanisms. A user may initiate a call or answer an incoming call displayed on a smart phone. The performance of conference application 101 has various perspectives in that it can be evaluated in isolation and separate from a host OS and host device, evaluated in combination with the OS, or evaluated as a whole with the OS and user device. Other implementations apply the techniques herein to other types of software applications. Implementation of the conference application 101A can be, for example, by downloading code from an Internet database and installing on a device. In one implementation, a server on the LAN or on the Internet provides intermediary services between peers when conducting conferences.

The conference application 140A executes in user device 140A. In other embodiments, the conference application 140A primarily executes on conference server 111 and conference application 140A displays window with a pre-processed video stream. FIG. 1 shows conference application 101A in conference with conference application 101B via conference server 111. The user experience can be with respect to a local user of user device 140A or with respect to a remote user of user device 120B.

The performance of channel networks can also have various perspectives. One embodiment of network experience includes every aspect of experience outside of conference application 101. A second embodiment of network experience is based on hardware networking devices and transmission mediums of a local LAN and/or the Internet. Still another embodiment of network experience is based on a cloud-based conference server (e.g., Zoom server).

The AI operations server 110 generates an experience predication module to proactively predict user experiences on conference applications. Sensors around the network logs data passively and actively to build a database of network transactions from gateways, access points, routers, users and the like. The network data can include numerous features like signal to noise ratio (SNR), signal strength, data rates and channel utilization, each with dynamic, nonlinear behavior due to various wireless clients. Ultimately, a feature vector including wireless features, wired features and SD-WAN features can help predict a good or bad network experience. Similarly, an application experience can be predicted by a feature vector including data from application engine, wireless features, wireless features, wired feature (e.g., full scope), and SD-WAN features (full scope) to help classify as audio bad, video bad and audio good, video bad and audio bad, or good experience.

Ensemble techniques, such as Random Forest, reduce the variance in predictions, making it suitable for applications where uncertainty quantification is need as a probabilistic measure of Network Experience and Application Experience. The Random Forest model leverages input data to generate multiple decision trees through repeated resampling. Each decision tree predicts a label (e.g., “Good_Exp” or “Bad_Exp”) for the input data, and the results are aggregated using majority voting to determine the final label. By analyzing these probability-based classifications, the system can derive valuable insights. This model not only provides a label indicating the experience quality (Good_Exp or Bad_Exp) but also identifies the root cause for each Bad_Exp, enabling it to recommend actionable insights to network administrators for effective issue resolution. Other implementations provide alternative labels.

In one embodiment, the AI operations server 110 uses Exploratory Data Analysis (EDA) to characterize and ensure feasibility of collected data. EDA discovers patterns and anomalies within data beyond, and prior to, modeling. An initial step is to example how the values of different variables are distributed using histograms, boxplots, cumulative distribution functions and quantile-quantile plots. Analyzing a distribution of data can reveal multiple features that cannot be used for various reasons, such as unique values, null values, ANOVA and Chi-square analysis (to study P value, etc.).

A correlation analysis can be performed to obtain features which are highly correlated with the label. Further cleaning of these features is done to remove certain features which convey the same meaning, such as data rate and station rate. One example gleans the following feature set for determining Network Experience: data_rate_bps, sta_rxrate_score, bandwidth_rx_AP, bandwidth_tx_WC, sta_txrate, sta_txrate_score, SNR, channel_utilization_percent, and sta_rxrate. By contrast, the following feature set is gleaned for determining Application Experience: sta_rxrate_score, sta_txrate_score, tx_retries_percent_AP, OS, channel_utilization_percent, bandwidth_rx_kbps, SNR, channel_utilization_percent and tx_discard_percentage_AP. Features can be weighted. Then machine learning algorithms, and other statistical modeling, can automatically detect anomalies and suspicious behavior based on insights gained from EDA, to improve accuracy over raw data.

In another embodiment, once data is considered feasible, feature engineering is performed to add and eliminate features for the most ideal modeling. Random Forest, for instance, is used to train data. Grid search CV can be used for hyperparameter tuning. Once the model is evaluated and approved, Time Block Analysis is carried out on results to limit data to a sliding window. During model maintenance phase, if accuracy drops, the model will be taken up for retraining using EDA.

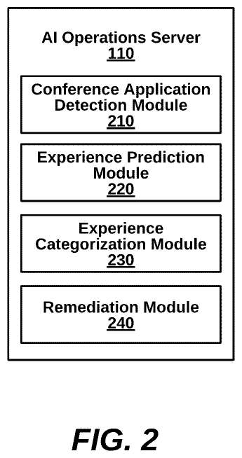

The AI operations server 110 can be a single device, or can be distributed among cooperating devices. In another embodiment, a third-party server provides offloading support from the Internet to local devices. A detailed example of the AI operations server 110 is described below with respect to FIG. 2.

Network sensors 1-5 can be placed at various locations on along a network channel while network sensors 6-7 can be placed at endpoints of conference application 101A and conference application 101B. Network sensors 1-5 include user device 140A (sensor 1), access point 130 (sensor 2), gateway device 120 (sensor 3). Placement can also be outside of the enterprise network, such as at user device 120B (sensor 4) and conference server 111 (sensor 5). An individual sensor can remotely analyze data packets of a device (e.g., sensor 1 involves access point 130 analyzing data packets of user device 140A). An individual sensor can also be integrated directly into the conference application or OS. The sensors 1-7 can be implemented as software patches or daemons within network devices. Alternatively, sensors can be independent devices placed to interrupt a physical port or placed to interrupt a wire between network devices. A wireless network sensor includes a Wi-Fi receiver. Another example receives logs collected from existing Security Information and Event Management (SIEM) devices.

FIG. 2 is a more detailed view of the AI operations server 110 of FIG. 1, according to an embodiment. The AI operations server 110 further includes a conference app detection module 210, an experience prediction module 220, an experience categorization module 230 and a remediation module 240. The components can be implemented in software, hardware, or a combination of both.

The conference app detection module 210 monitors data traffic associated with a specific station on the enterprise network. The conference app detection module 210 detects a conference application currently running on a specific station from data packets associated with the specific station.

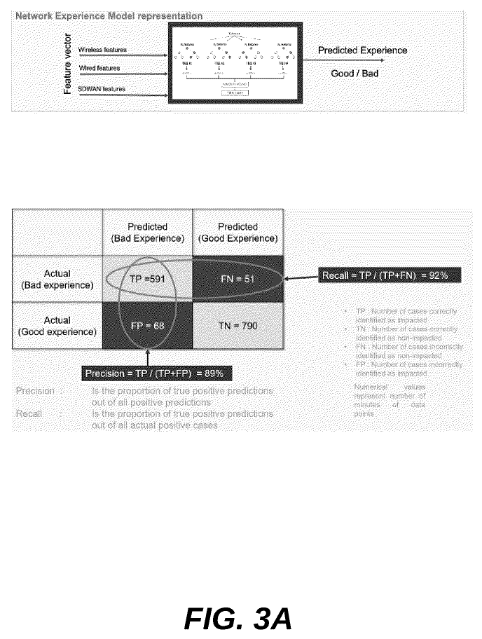

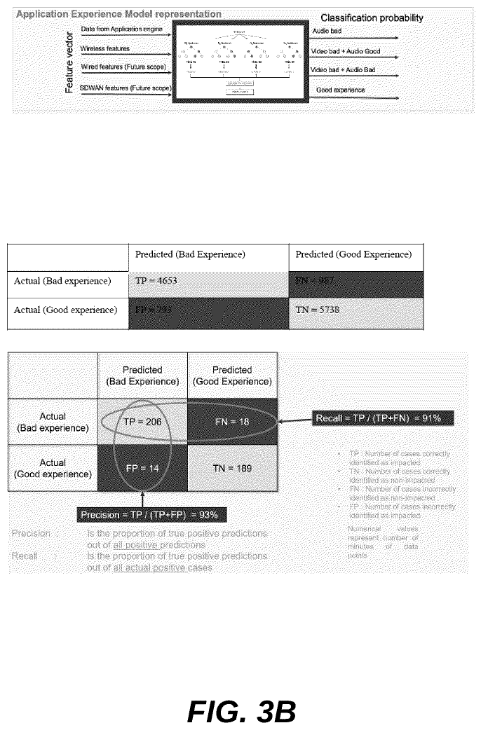

The experience prediction module 220, in an embodiment, predicts, with an experience prediction model, a set of channel experiences and a set of conference application experiences within a sliding time window. A data collection module 222 monitors data collected at a database (e.g., at one minute intervals at an access point and a Wi-Fi client for overall client experience). An EDA module 224 ensures data feasibility. An experience prediction model 226 can be trained with Random Forest, or other ensemble techniques, using validated channel statistics, the channel statistics are collected at network sensors dispersed at different locations on the enterprise network, and feasibility of at least portions of collected statistics are tested using Exploratory Data Analysis to determine anomalies between training results and testing result. A maintenance module 226 monitors model accuracy and triggers retraining when needed. Actual user feedback of experience can be one input for tracking model accuracy. FIG. 3A illustrates feature vectors selected for evaluating a network experience model while FIG. 3B illustrates feature vectors selected for evaluating a conference application model, both using Random Forrest. To do so, actual experiences are plotted against predicted experiences, as shown.

The experience categorization module 230 categorizes the set channel predictions and the set of conference application experiences, to determine whether a user experience is good or bad, and whether the user experience is predominately based on the network experience or the conference application experience. In one case, experiments depicting various real-world scenarios are conducted to identify data sets which would correspond to clients and applications having a Good or Bad Experience. Example scenarios include, high interference with distant client (i.e., low RSSI) test to simulate a bad scenario; high interference with nearby client to simulate a good scenario; high interference with a mid-range client to test to simulate a good scenario; moderate interference with a distant client to simulate a bad scenario; moderate interference with distant and mid-range client to simulate good scenarios; and moderate interference with distant and nearby clients to simulate good scenarios. In another case, experience categorization module 230 also collects actual user experience by asking users to categorize their experience during or after a conference.

The remediation module 240 can take an action based on the categorization. Some implementations can automatically find and apply solutions to bad experiences. Other implementations alert network administrators, and still other implementations make periodic reporting of issues. One implementation responds to user confirmation of a bad experience. An alternative implementation responds to user confirmation a good experience, in order to maintain the experience.

There are numerous variations to those that are listed herein, that would be apparent to one of ordinary skill in the art, given the disclosure herein.

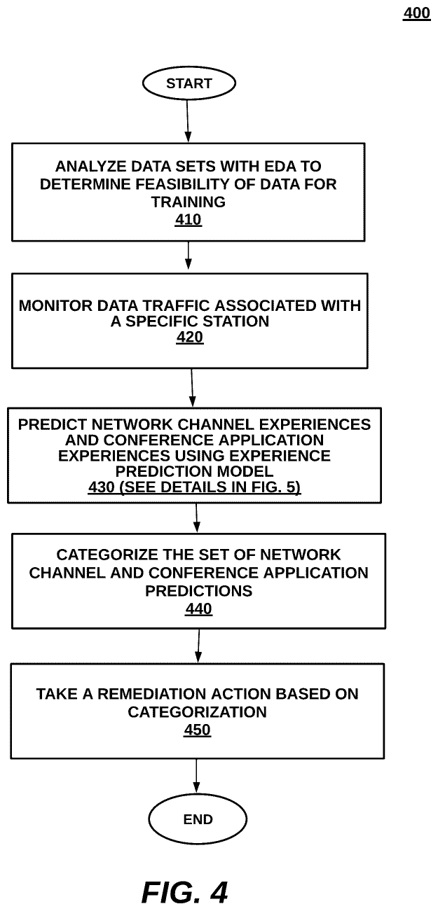

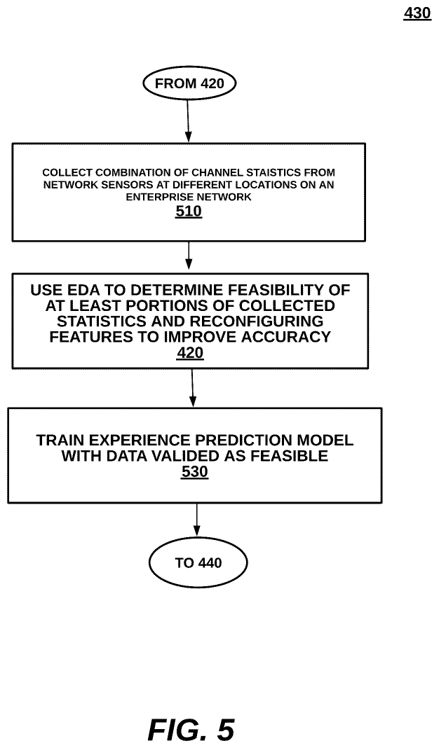

### II. Methods for Conference Application Experience (FIGS. 4-5)

FIG. 4 is a high-level flow diagram of a method 400 for proactively identifying problems in user experience with machine learning when using conference applications, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, data sets are analyzed with EDA for determining feasible data for training, as set forth in detail below in association with FIG. 5.

At step 420, data traffic associated with a specific station on the enterprise network is monitored, along with other stations. Monitoring of stations can be passive by snooping data packets, and can be active by direct communication with an operating system. For example, the operating system assists execution of a conference application and can send a notification. A conference application currently running on a specific station is detected from data packets associated with the specific station.

At step 430, a set of channel experiences and a set of conference application experiences are predicted using the experience prediction model. A sliding window can define a time period for predictions (e.g., 1, 3, or 15 minute windows) and weighting can define relativity between different inputs. The experience prediction module has been trained with validated channel statistics collected at network sensors dispersed at different locations on the enterprise network.

At step 440, the set of channel predictions and the set of conference application experiences are categorized to determine whether the network experience or the conference application experience are predominately network based, predominately device based, or a combination. When an accuracy of predictions falls below a threshold, the experience predication model can be retrained with more feasible data.

At step 450, an action is taken based on the categorization. For example, a network administrator can be notified, an automated action can be taken, or conditions can be reported in batch or as discovered.

FIG. 5 is a high-level flow diagram of the step 410 of determining feasible training data by analyzing data sets with EDA, according to an embodiment.

At step 510, a predetermined combination of channel statistics from a plurality of channel statistics available, is collected from network sensors dispersed at different locations of the enterprise network.

At step 520, feasibility of at least portions of collected statistics is determined using EDA to determine anomalies between training results and testing results. In some embodiments, features are eliminated and added based on EDA, to find an combination of features that improves feasibility.

At step 530, responsive to feasibility of collected statistics, an experience prediction model is trained (or re-trained) using Random Forest modeling.

### III. Computing Device for Conference Application Experience (FIG. 6)

FIG. 6 is a block diagram illustrating a computing device 600, for use in the system 100 of FIG. 1 in automatic virtual patching, according to one embodiment. The computing device 600 is a non-limiting example device for implementing each of the components of the system 100, including AI operations device 110, gateway device 120, access point 140 and user device 140. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., FortiOS, Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

We claim:

1. An artificial intelligence (AI) operations device, on an enterprise network, for proactively identifying problems in user experience with machine learning when using conference applications, the network device comprising:
monitoring data traffic associated with a specific station on the enterprise network;
detecting a conference application currently running on a specific station from data packets associated with the specific station;
predicting, with an experience prediction model, a set of channel experiences and a set of conference application experiences within a sliding time window;
wherein the experience prediction model is trained using Random Forest on validated channel statistics, the channel statistics are collected at network sensors dispersed at different locations on the enterprise network, and feasibility of at least portions of collected statistics are tested using Exploratory Data Analysis to determine anomalies between training results and testing result;
categorizing the set channel predictions and the step of conference application experiences to determine whether a user experience is good or bad, and whether the user experience is predominately based on the network experience or the conference application experience; and
taking an action based on the categorization.

2. The method of claim 1, further comprising:
responsive to non-feasibility of collected statistics, precluding the collected statistics from the step of training the experience prediction model.

3. The method of claim 1, wherein:
the step of detecting the conference application upstream and downstream data packets associated with the specific station.

4. The method of claim 1, wherein the step of taking an action comprises notifying an network administrator and/or a user.

5. A non-transitory computer-readable medium in a network device, on a data communication network, proactively identifying problems in user experience with machine learning when using conference applications, the method comprising:
monitoring data traffic associated with a specific station on the enterprise network;
detecting a conference application currently running on a specific station from data packets associated with the specific station;
predicting, with an experience prediction model, a set of channel experiences and a set of conference application experiences within a sliding time window;
wherein the experience prediction model is trained using Random Forest on validated channel statistics, the channel statistics are collected at network sensors dispersed at different locations on the enterprise network, and feasibility of at least portions of collected statistics are tested using Exploratory Data Analysis to determine anomalies between training results and testing result;
categorizing the set channel predictions and the step of conference application experiences to determine whether a user experience is good or bad, and whether the user experience is predominately based on the network experience or the conference application experience; and
taking an action based on the categorization.

6. A network device for proactively identifying problems in user experience with machine learning when using conference applications, the network device comprising:
a processor;
a network interface communicatively coupled to the processor and to a data communication network; and
a memory, communicatively coupled to the processor and storing:
a conference application detection module to monitor data traffic associated with a specific station on the enterprise network,
wherein the traffic monitoring module detects a conference application currently running on a specific station from data packets associated with the specific station;
an experience prediction module to predict, with an experience prediction model, a set of channel experiences and a set of conference application experiences within a sliding time window,
wherein the experience prediction model is trained using Random Forest on validated channel statistics, the channel statistics are collected at network sensors dispersed at different locations on the enterprise network, and feasibility of at least portions of collected statistics are tested using Exploratory Data Analysis to determine anomalies between training results and testing result;
experience categorization module to categorize the set channel predictions and the step of conference application experiences to determine whether a user experience is good or bad, and whether the user experience is predominately based on the network experience or the conference application experience; and
a remediation module to take an action based on the categorization.
